(19) United States
(12) Patent Application Publication
(10) Pub. No.: US 2008/0309597 A1
(43) Pub. Date: Dec. 18, 2008

(54) DRIVING APPARATUS FOR A LIQUID CRYSTAL DISPLAY AND LIQUID CRYSTAL DISPLAY INCLUDING THE SAME

(75) Inventors: Hyun-Woo Nam, Asan-si (KR); Hwan-Jun SUNG, Cheonan-si (KR); Myoung-Ha Jeon, Cheonan-si (KR); Hyeok-Tae Kwon, Daegu-si (KR); Hyo-Hyun Park, Deagu-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/040,032

(22) Filed: Feb. 29, 2008

(30) Foreign Application Priority Data
Jun. 18, 2007 (KR) 10-2007-0059333

(51) Int. Cl. G09G 3/36

(52) U.S. Cl. 345/87

(57) ABSTRACT

The present invention is related to a driving apparatus for a liquid crystal display, and a liquid crystal display including the same. A gate-on voltage generator includes first and second resistors connected between a predetermined reference voltage and a ground voltage, a voltage follower connected to a contact between the first resistor and the second resistor, a charge pump circuit connected to an output terminal of the voltage follower, and a gate-on voltage output terminal connected to the charge pump circuit. The voltage follower is disposed in front of the charge pump circuit such that an influence due to load changes is blocked to thereby prevent an excessive increase of the gate-on voltage during a blank time. Furthermore, two resistors having the same resistance are used to divide the reference voltage such that stress on the resistors may be minimized.

This application claims priority to Korean Patent Application No. 10-2007-0059333 filed on Jun. 18, 2007, all of the benefits accruing therefrom under 35 U.S.C. § 119, the contents of which in its entirety is incorporated herein by reference.

### BACKGROUND OF THE INVENTION

1. Field of the Invention

The present invention is related to a driving apparatus for a liquid crystal display and a liquid crystal display including the same.

2. Description of the Related Art

Recently, flat panel displays such as liquid crystal displays (“LCDs”), organic light emitting displays (“OLEDs”), and plasma display panels (“PDPs”) have been developed as substitutes for cathode ray tubes (“CRTs”) having a large size and weight.

The PDPs are devices which display characters or images using plasma generated by a gas discharge. The OLEDs are devices which display characters or images by applying an electric field to specific light emitting organic or high molecule materials. The LCDs are devices which display images by applying an electric field to a liquid crystal layer disposed between two panels and regulating the strength of the electric field to adjust transmittance of light passing through the liquid crystal layer.

The LCD includes a panel assembly having pixels including switching elements and display signal lines, and a gate driver, i.e., a shift register which provides a gate signal for gate lines of the display signal lines to turn the switching elements on and off.

The shift register includes a plurality of stages which are connected to each other, and each of the stages includes a plurality of transistors.

The shift register is synchronized with a clock signal of a plurality of clock signals, and sequentially supplies a gate-on voltage and a gate-off voltage to the gate lines.

Here, a gate voltage generator which generates the gate-on voltage and the gate-off voltage receives a predetermined reference voltage, generates gate voltages using a charge pump circuit in response to the predetermined reference voltage, and supplies the generated gate voltages to the gate driver and a clock signal generator which generates clock signals.

However, there are blank times at which the clock signals are not generated between frames, and the gate-on voltage is greatly increased such that the gate-on voltage may come close to or exceed the limit value of an operation specification of the gate voltage generator.

### BRIEF SUMMARY OF THE INVENTION

The present invention has made an effort to solve the above stated problems and aspects of the present invention provide a driving apparatus for a liquid crystal display and a liquid crystal display including the same which satisfy an operation specification of a gate voltage generator thereof.

According to an exemplary embodiment, the present invention provides a driving apparatus for a liquid crystal display which includes a gate-on voltage generator which generates a gate-on voltage, and a gate-off voltage generator which generates a gate-off voltage.

The gate-on voltage generator includes first and second resistors connected between a predetermined reference voltage and a ground voltage, a voltage follower connected to a contact between the first resistor and the second resistor, a charge pump circuit connected to an output terminal of the voltage follower, and a gate-on voltage output terminal connected to the charge pump circuit.

According to an exemplary embodiment, the resistances of the first and second resistors are the same.

According to an exemplary embodiment, the charge pump circuit includes first, second, third and fourth diodes sequentially connected between the output terminal of the voltage follower and the gate-on voltage output terminal, a first capacitor having a terminal thereof connected to a first node between the first diode and the second diode, and another terminal thereof receiving a switching voltage, a second capacitor having a terminal connected to a second node between the second diode and the third diode and another terminal which receives the reference voltage, a third capacitor having a terminal connected to a third node between the third diode and the fourth diode and another terminal which receives the switching voltage, and a fourth capacitor having a terminal connected to a fourth node between the fourth diode and the gate-on voltage output terminal and another terminal which receives the reference voltage.

According to an exemplary embodiment, the driving apparatus further includes a clock signal generator which receives the gate-on voltage and the gate-off voltage and generates a plurality of clock signals may be further included.

According to an exemplary embodiment, the driving apparatus further includes a gate driver which generates gate voltages based on the clock signals.

According to an exemplary embodiment, the gate driver includes a plurality of stages which sequentially generate the gate voltages, and the plurality of stages may be integrated on the liquid crystal display.

According to an exemplary embodiment, the reference voltage is approximately 12V, and the switching voltage includes a value from approximately 0V to approximately 12V.

According to another exemplary embodiment, the present invention provides a liquid crystal display which includes a plurality of pixels disposed in a matrix, a plurality of switching elements connected to the pixels, a gate driver which generates driving voltages for sequentially turning on and turning off the switching elements, and a gate voltage generator including a gate-on voltage generator which generates a gate-on voltage and a gate-off voltage generator which generates a gate-off voltage. The gate-on voltage generator includes first and second resistors connected between a predetermined reference voltage and a ground voltage, a voltage follower connected to a contact between the first resistor and the second resistor, a charge pump circuit connected to an output terminal of the voltage follower, and a gate-on voltage output terminal connected to the charge pump circuit.

According to an exemplary embodiment, the resistances of the first and second resistors are the same.

According to an exemplary embodiment, the charge pump circuit includes first, second, third and fourth diodes sequentially connected between the output terminal of the voltage follower and the gate-on voltage output terminal, a first capacitor having a terminal connected to a first node between the first diode and the second diode and another terminal which receives a switching voltage, a second capacitor having a terminal connected to a second node between the second diode and the third diode and another terminal which receives the reference voltage, a third capacitor having a terminal connected to a third node between the third diode and the fourth diode and another terminal which receives the switching voltage, and a fourth capacitor having a terminal connected to a fourth node between the fourth diode and the gate-on voltage output terminal and another terminal which receives the reference voltage.

According to an exemplary embodiment, the liquid crystal display further includes a clock signal generator which receives the gate-on voltage and the gate-off voltage and generates a plurality of clock signals.

According to an exemplary embodiment, the gate driver generates the driving voltages based on the clock signals.

According to an exemplary embodiment, the gate driver includes a plurality of stages which sequentially generate the driving voltages, and the stages may be integrated on the liquid crystal display.

### BRIEF DESCRIPTION OF THE DRAWINGS

The above and/or other aspects, features and advantages of the present invention will become more apparent from the following detailed description when taken in conjunction with the accompanying drawings, in which:

FIG. 1 is a block diagram of an exemplary embodiment of a liquid crystal display according to the present invention.

FIG. 2 is an equivalent circuit diagram of an exemplary embodiment of a pixel of a liquid crystal display according to.

FIG. 3 is a block diagram of an exemplary embodiment of a gate driver according to the present invention.

FIG. 4 is an exemplary circuit diagram of an exemplary embodiment of a j-th stage of the shift register for the gate driver shown in FIG. 3, according to the present invention.

FIG. 5 is a signal waveform of an exemplary embodiment of the gate driver shown in FIG. 3, according to the present invention.

FIG. 6 is an exemplary circuit diagram of an exemplary embodiment of a gate-on voltage generator of the gate voltage generator shown in FIG. 1, according to the present invention.

FIG. 7 is a circuit diagram of a conventional gate-on voltage generator.

FIG. 8 is a view of signal waveforms comparing the gate-on voltages of the gate-on voltage generators according to an exemplary embodiment of the present invention and the conventional art.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

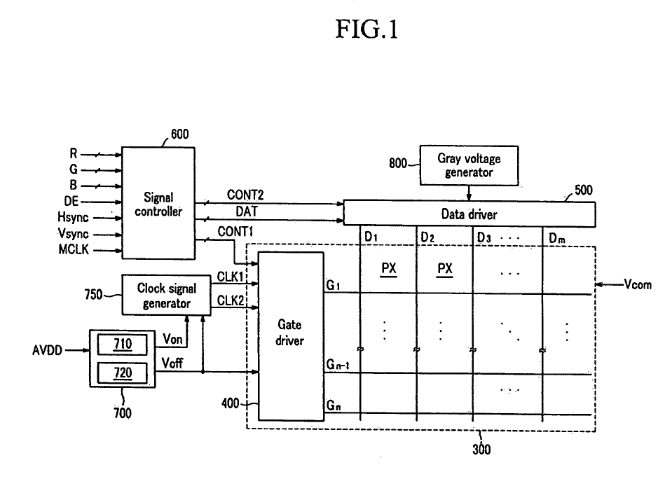

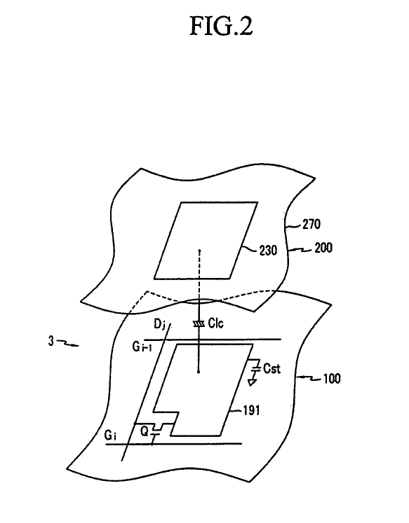

A liquid crystal display according to an exemplary embodiment of the present invention will be described with reference to FIGS. 1 and 2.

FIG. 1 is a block diagram of an exemplary embodiment of a liquid crystal display according to the present invention, and FIG. 2 is an equivalent circuit diagram of an exemplary embodiment of a pixel of a liquid crystal display according to the present invention.

Referring to FIG. 1, a liquid crystal display according to an exemplary embodiment of the present invention includes a liquid crystal panel assembly 300, a gate driver 400 and a data driver 500 connected thereto, a gate voltage generator 700 and a clock signal generator 750 connected to the gate driver 400, a gray voltage generator 800 connected to the data driver 500, and a signal controller 600 which controls the above-described elements.

Referring to the equivalent circuit, the liquid crystal panel assembly 300 includes a plurality of signal lines G₁-Gₙ and D₁-Dₘ, and a plurality of pixels PX connected to the signal lines G₁-Gₙ and D₁-Dₘ and arranged in a matrix structure. On the other hand, referring to FIG. 2, the liquid crystal panel assembly 300 includes the lower and upper panels 100 and 200 facing to each other, and a liquid crystal (“LC”) layer 3 formed between the lower panel 100 and the upper panel 200.

The signal lines G₁-Gₙ and D₁-Dₘ include a plurality of gate lines G₁-Gₙ which transmit gate signals (i.e., scanning signals), and a plurality of data lines D₁-Dₘ which transmit data signals. The gate lines G₁-Gₙ extend in a row direction and are parallel to each other, while the data lines D₁-Dₘ extend y in a column direction and are parallel to each other.

Referring to FIG. 2, each pixel PX connected to the i-th gate line Gi (i=1, 2, . . . , n) and the j-th data line Dj (j=1, 2, . . . , m), includes a switching element Q connected to the signal lines Gi and Dj and an LC capacitor Clc and a storage capacitor Cst which are connected to the switching element Q. According to an exemplary embodiment, the storage capacitor Cst may be omitted.

The switching element Q is disposed on the lower panel 100 and includes three terminals, (i.e., a control terminal connected to the gate line Gi, an input terminal connected to the data line Dj, and an output terminal connected to the LC capacitor Clc and the storage capacitor Cst).

The LC capacitor Clc includes a pixel electrode 191 disposed on the lower panel 100 and a common electrode 270 disposed on the upper panel 200 as two terminals. The LC layer 3 is disposed between the two electrodes 191 and 270 and functions as a dielectric of the LC capacitor Clc. The pixel electrode 191 is connected to the switching element Q, and the common electrode 270 is supplied with a common voltage Vcom and covers an entire surface of the upper panel 200. Unlike FIG. 2, according to another exemplary embodiment, the common electrode 270 is provided on the lower panel 100, and at least one of the electrodes 191 and 270 is a shape of a bar or a stripe.

The storage capacitor Cst is an auxiliary capacitor for the LC capacitor Clc. The storage capacitor Cst includes the pixel electrode 191 and a separate signal line, which is provided on the lower panel 100, overlaps the pixel electrode 191 via an insulator (not shown), and is supplied with a predetermined voltage such as the common voltage Vcom. Alternatively, according to another exemplary embodiment, the storage capacitor Cst includes the pixel electrode 191 and an adjacent gate line called a “previous” gate line, which overlaps the pixel electrode 191 via an insulator.

For color display, each pixel PX uniquely represents one of primary colors (i.e., spatial division) or each pixel sequentially represents the primary colors in turn (i.e., temporal division) such that a spatial or temporal sum of the primary colors is recognized as a desired color. An example of a set of the primary colors includes red, green, and blue-colors. FIG. 2 illustrates an example of the spatial division in which each pixel includes a color filter 230 representing one of the primary colors in an area of the upper panel 200 facing the pixel electrode 191. Alternatively, according to another exemplary embodiment, the color filter 230 is provided on or under the pixel electrode 191 on the lower panel 100.

According to an exemplary embodiment, one or more polarizers (not shown) are attached to outer surfaces of the panel assembly 300.

Referring to FIG. 1 again, the gray voltage generator 800 generates two sets of a plurality of (reference) gray voltages related to the transmittance of the pixels PX. The (reference) gray voltages in one set have a positive polarity with respect to the common voltage Vcom, while those in the other set have a negative polarity with respect to the common voltage Vcom.

The gate driver 400 is integrated on the LC panel assembly 300 along with the switching elements Q in the pixel PX, is connected to the gate lines G1-Gn of the LC panel assembly 300, and synthesizes a gate-on voltage Von and a gate-off voltage Voff, to generate the gate signals for application to the gate lines G1-Gn.

The gate voltage generator 700 includes a gate-on voltage generator 710 which generates a gate-on voltage Von and a gate-off voltage generator 720 which generates a gate-off voltage Voff, and the gate-on voltage Von is output to the clock signal generator 750 and the gate-off voltage Voff is output to the clock signal generator 750 and the gate driver 400.

The clock signal generator 750 receives the gate-on voltage Von and the gate-off voltage Voff, generates a plurality of clock signals CLK1 and CLK2 having different phases, and outputs the clock signals CLK1 and CLK2 to the gate driver 400.

The data driver 500 is connected to the data lines D1-Dm of the LC panel assembly 300 and applies data signals, which are selected from the gray voltages supplied from the gray voltage generator 800, to the data lines D1-Dm. However, when the gray voltage generator 800 generates only a few of the reference gray voltages rather than all the gray voltages for all the grays, the data driver 500 may divide the reference gray voltages, to generate all the gray voltages and select the data voltages from among the gray voltages.

The signal controller 600 controls the gate driver 400 and the data driver 500.

According to an exemplary embodiment, each of driving devices, the data driver 500, the signal controller 600, and the gray voltage generator 800 may include at least one integrated circuit (“IC”) chip mounted on the LC panel assembly 300 or on a flexible printed circuit (“FPC”) film in a tape carrier package (“TCP”) type, which are attached to the LC panel assembly 300. Alternatively, according to another exemplary embodiment, at least one of the driving devices the data driver 500, the signal controller 600, and the gray voltage generator 800 may be integrated into the LC panel assembly 300 along with the signal lines G1-Gn and D1-Dm and the switching elements Q. Furthermore, the gate driver 400, the data driver 500, the signal controller 600, and the gray voltage generator 800 may be integrated into a single IC chip, but at least one of the driving devices 400, 500, 600, and 800 or at least one circuit element in at least one of the driving devices 400, 500, 600, and 800 may be disposed out of the single IC chip.

Now, the operation of the above-described LCD will be described in detail.

The signal controller 600 is supplied with input image signals R, G, and B and input control signals for controlling the display thereof from an external graphics controller (not shown). The input control signals include a vertical synchronization signal Vsync, a horizontal synchronization signal Hsync, a main clock signal MCLK, and a data enable signal DE.

On the basis of the input control signals and the input image signals R, G, and B, the signal controller 600 generates gate control signals CONT1 and data control signals CONT2 and processes the image signals R, G, and B to be suitable for the operation of the LC panel assembly 300. The signal controller 600 sends the gate control signals CONT1 to the gate driver 400 and sends the processed image signals DAT and the data control signals CONT2 to the data driver 500.

The gate control signals CONT1 include a scanning start signal STV for instructing to start scanning and at least one clock signal for controlling the output period of the gate-on voltage Von. According to an exemplary embodiment, the scanning control signals CONT1 may include an output enable signal OE for defining the duration of the gate-on voltage Von.

The data control signals CONT2 includes a horizontal synchronization start signal STH which informs a start of data transmission for a row [group] of pixels PX, a load signal LOAD which instructs the application of the data signals to the data lines D₁-Dₘ, and a data clock signal HCLK. According to another exemplary embodiment, the data control signal CONT2 further includes an inversion signal RVS which reverses the polarity of the voltage of the data signals (with respect to the common voltage Vcom).

In response to the data control signals CONT2 from the signal controller 600, the data driver 500 receives a packet of the digital image signals DAT for the row [group] of pixels PX from the signal controller 600, converts the digital image signals DAT into analog data signals selected from the gray voltages, and applies the analog data signals to the data lines D1-Dm.

The gate driver 400 applies the gate-on voltage Von to a gate line G1-Gn in response to the scanning control signals CONT1 from the signal controller 600, thereby turning on the switching transistors Q connected thereto. The data signals applied to the data lines D1-Dm are then supplied to the pixels PX through the activated switching transistors Q.

The difference between the voltage of a data signal applied to a pixel PX and the common voltage Vcom is represented as a charged voltage of the LC capacitor Clc of the pixel PX, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts the light polarization into light transmittance such that the pixel PX includes a luminance represented by a gray of the data signal.

By repeating this procedure by a unit of a horizontal period (also referred to as “1H” and that is equal to one period of the horizontal synchronization signal Hsync and the data enable signal DE), all gate lines G₁-Gₙ are sequentially supplied with the gate-on voltage Von, thereby applying the data signals to all pixels PX to display an image for a frame.

When the next frame starts after one frame finishes, the inversion control signal RVS applied to the data driver 500 is controlled such that the polarity of the data signals is reversed (which is referred to as “frame inversion”). The inversion control signal RVS may be also controlled such that the polarity of the data signals flowing in a data line are periodically reversed during one frame (for example, row inversion and dot inversion), or the polarity of the data signals in one packet are reversed (for example, column inversion and dot inversion).

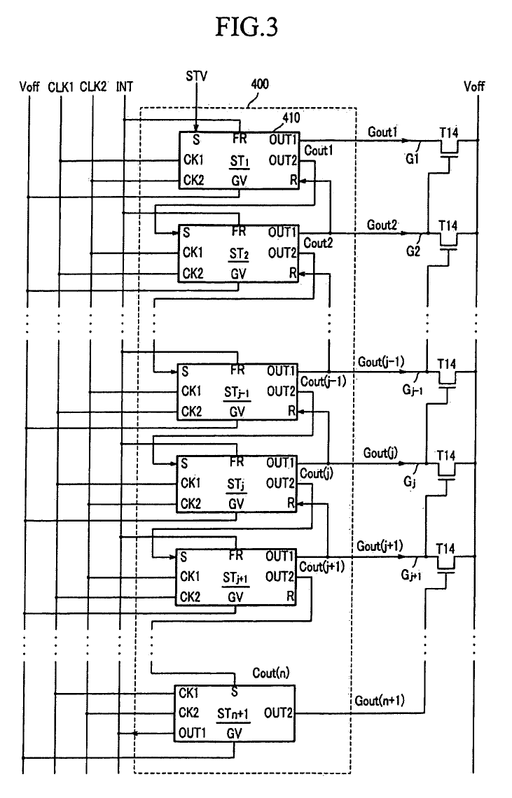

Now, a gate driver of a liquid crystal display according to an exemplary embodiment of the present invention will be described in more detail with reference to FIGS. 3-5.

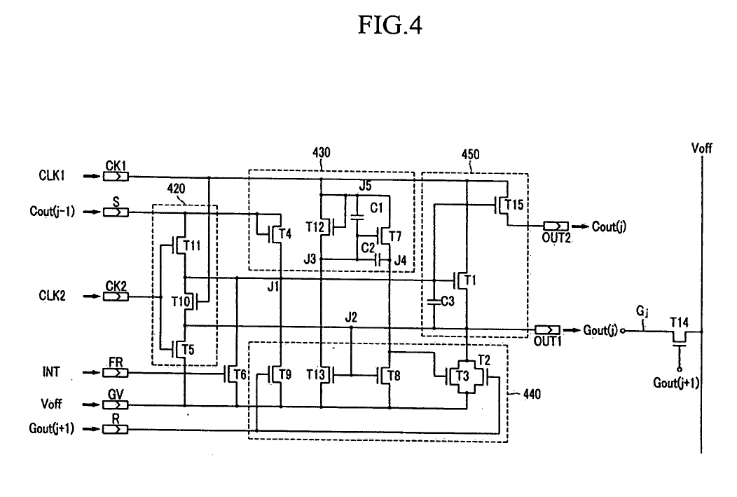

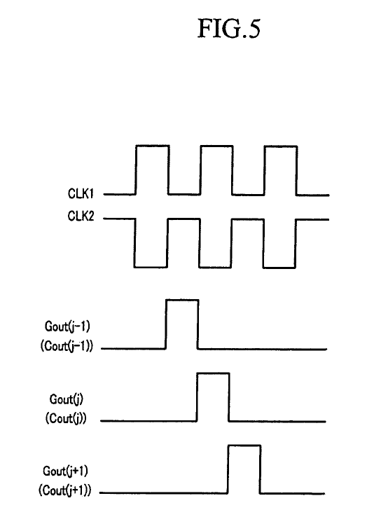

FIG. 3 is a block diagram of an exemplary embodiment of a gate driver according to the present invention, FIG. 4 is circuit diagram of an exemplary embodiment of a j-th stage of a shift register for the gate driver shown in FIG. 3, and FIG. 5 shows waveforms of signals of the gate driver shown in FIG. 3, according to the present invention.

Referring to FIG. 3, the gate driver 400 is a shift register which includes a plurality of stages 410 arranged in a line and connected to the gate lines G1-Gn. The gate driver 400 is applied with a scanning start signal STV, a gate-off voltage Voff, clock signals CLK1 and CLK2, and an initializing signal INT. The end of each gate line G1-Gn is connected to an NMOS transistor T14 and is applied with the gate-off voltage Voff.

Each of the stages 410 includes a set terminal S, a gate-off voltage terminal GV, a pair of clock terminals CK1 and CK2, a reset terminal R, a frame reset terminal FR, a gate output terminal OUT1, and a carry output terminal OUT2. However, the final dummy stage does not have the reset terminal R and the frame reset terminal FR.

According to an exemplary embodiment, each of the stages 410, for example the set terminal S of the j-th stage STj, is supplied with a carry output of a previous stage STj−1, i.e., a previous carry output, and the reset terminal thereof is supplied with a gate output of a next stage STj+1, i.e., a next gate output Gout(j+1). The clock terminals CK1 and CK2 thereof receive the clock signals CLK1 and CLK2, respectively, the gate voltage terminal GV receives the gate-off voltage Voff, and the frame reset terminal FR receives the initializing signal INT. The gate output terminal OUT1 outputs a gate output Gout(j) and the carry output terminal OUT2 outputs a carry output Cout(j).

However, the set terminal S of an initial stage ST1 of the left shift register 400 is supplied with the vertical synchronization start signal STV instead of the previous gate output. Additionally, when the clock terminals CK1 and CK2 of the j-th stage receive the clock signal CLK1 and CLK2, respectively, the clock terminals CK1 of the (j−1)-th stage STj−1 and the (j+1)-th stage STj+1 receive the clock signal CLK2 and the clock terminals CK2 thereof receive the clock signal CLK1.

According to an exemplary embodiment, each clock signal CLK1 and CLK2 is the gate-on voltage Von for a high interval and is the gate-off voltage Voff for a low interval in order to drive the switching elements Q of the pixels. As shown in FIG. 5, according to an exemplary embodiment, the duty ratio and the phase difference of the clock signals CLK1 and CLK2 is approximately 50% and 180 degrees, respectively.

Referring to FIG. 4, each of the stages 410 of the gate driver 400 according to an exemplary embodiment of the present, invention, for example, the j-th stage STj, includes an input unit 420, a pull-up driving unit 430, a pull-down driving unit 440, and an output unit 450. Each of the input unit 420, the pull-up driving unit 430, the pull-down driving unit 440, and the output unit 450 includes at least an NMOS transistor, T1-T15, which act as an electrical conduction path between a drain and a source of each transistor controlled by an input at a gate of each transistor T1-T15. The pull-up driving unit 430 and the output unit 450 further include capacitors C1-C3. According to another exemplary embodiment of the present invention, the NMOS transistors may be replaced by PMOS transistors. In addition, the capacitors C1-C3 may be parasitic capacitances between a gate and either a drain or a source formed during a manufacturing method.

The input unit 420 includes three transistors T11, T10, and T5 connected sequentially in series between the set terminal S and the gate voltage terminal GV. Gates of the transistors T11 and T5 are connected to the clock terminal CK2, and the clock terminal CK1 of the transistor T10 is connected to the clock terminal CK1. A point of contact between the transistor T11 and the transistor T10 is connected to a contact J1, and a point of contact between the transistor T10 and the transistor T5 is connected to a contact J2.

The pull-up driving unit 430 includes a transistor T4 connected between the set terminal S and the contact J1, a transistor T12 connected between the clock terminal CK1 and a contact J3, and a transistor T7 connected between the clock terminal CK1 and a contact J4. The transistor T4 includes a gate and a drain commonly connected to the set terminal S and a source connected to the contact J1, and the transistor T12 includes a gate and a drain commonly connected to the clock terminal CK1 and a source connected to the contact J3. The transistor T7 includes a gate connected to the contact J3 and also connected to the clock terminal CK1 via the capacitor C1, and a drain connected to the clock terminal CK1 and a source connected to the contact J4. The capacitor C2 is connected between the contact J3 and the contact J4.

The pull-down driving unit 440 includes transistors T6, T9, T13, T8, T3, and T2 applied with the gate-off voltage V_{off} via sources thereof for output to the contacts J1-J4. A gate and a drain of the transistor T6 are connected to the frame reset terminal FR and the contact J1, respectively, and a gate and a drain of the transistor T9 are connected to the reset terminal R and the contact J1, respectively. Gates of the transistors T13 and T8 are commonly connected to the contact J2, and drains thereof are connected to the contacts J3 and J4, respectively. A gate of the transistor T3 is connected to the contact J4, a gate of the transistor T2 is connected to the reset terminal R, and drains of the transistors T3 and T2 are commonly connected to the contact J2.

The output unit 450 includes transistors T1 and T15 and the capacitor C3. Drains and gates of the transistors T1 and T15 are connected to the clock terminal CK1 and the output terminals OUT1 and OUT2, and gates thereof are connected to the contact J1. The capacitor C3 is connected between the gate and the drain of the transistor T1, i.e., the contact J1 and the contact J2. A source of the transistor T1 is also connected to the contact J2.

Now, an operation of an exemplary embodiment of a stage 410 will be described in detail with reference to FIGS. 3-5.

For descriptive convenience, a voltage corresponding to the high levels of the clock signals CLK1 and CLK2 is referred to as a “high voltage”, and a voltage corresponding to the low levels thereof has the same magnitude as the gate-off voltage Voff and is referred to as a “low voltage”.

At first, when the clock signal CLK2 and the previous gate output signal Gout(j−1) are high, the transistors T11 and T5 and the transistor T4 are turned on. Two transistors T11 and T4 transmit the high voltage to the contact J1, and the transistor T5 transmits the low voltage to the contact J2. Thus, the transistors T1 and T15 are turned on and thereby the clock signal CLK1 is transmitted to the output terminals OUT1 and OUT2. At this time, since a voltage at the contact J2 and the clock signal CLK1 are low, the output voltages Gout(j) and Cout(j) are low. At the same time, the capacitor C3 charges a voltage of a magnitude corresponding to a difference between the high voltage and the low voltage.

In the current exemplary embodiment, the clock signal CLK1 and the next gate output Gout(j+1) are low and a voltage at the contact J2 is also low, and thereby the transistors T10, T9, T12, T13, T8, and T2, which have the gates connected thereto, are turned off.

Subsequently, when the clock signal CLK2 becomes low, the transistors T11 and T5 are turned off, and when the clock signal CLK1 simultaneously becomes high, an output voltage of the transistor T1 and a voltage at the contact J2 are the high voltage. Therefore, even though the high voltage is applied to the gate of the transistor T10, since the source voltage thereof connected to the contact J2 is also the high voltage, a voltage difference becomes zero and thereby the transistor T10 remains turned off. Accordingly, the contact J1 is in a floating state and a voltage of the contact J1 rises as much as the high voltage by the capacitor C3.

On the other hand, since the clock signal CLK1 and the contact J2 are the high voltage, the transistors T12, T13, and T8 are turned on. Therefore, the transistor T12 and the transistor T13 are connected in series between the high and low voltages, and thus, a voltage at the contact J3 becomes a voltage value divided by resistances in ohmic states at the turn-on time of the two transistors T12 and T13. In the current exemplary embodiment, when the resistance in the ohmic state at the turned-on time of the transistor T13 is set to be much larger, e.g., 10,000 times that of the transistor T12, a voltage at the contact J3 is substantially identical to the high voltage. Accordingly, the transistor T7 is turned on to be connected in series with the transistor T8, and thereby a voltage at the contact J4 becomes a voltage value divided by resistances in ohmic states at turn-on time of the two transistors T7 and T8. Therefore, when the resistances in the ohmic state at the turn-on time of the two transistors T7 and T8 are substantially set to be identical to each other, the voltage at the contact J4 becomes a middle value between the high and low voltages and thereby the transistor T3 remains turned off. Since the next gate output Gout(j+1) still remains low, the transistors T9 and T2 are turned off. Accordingly, the output terminals OUT1 and OUT2 are only connected to the clock signal CLK1, and are disconnected from the low voltage to output the high voltage.

Additionally, the capacitors C1 and C2 charge voltages corresponding to voltage differences developed at both terminals thereof, and a voltage at the contact J3 is lower than that of a contact J5.

Subsequently, when the next gate output Gout(j+1) and the clock signal CLK2 become high and the clock signal CLK1 becomes low, the transistors T9 and T2 are turned on to transmit the low voltage to the contacts J1 and J2. At this time, a voltage at the contact J1 decreases to the low voltage while the capacitor C3 discharges, and a certain amount of time is needed until the voltage at the contact J1 becomes the complete low voltage. Accordingly, two transistors T1 and T15 are turned on for a while after the next gate output Gout(j+1) becomes high, and thereby the output terminals OUT1 and OUT2 are connected to the clock signal CLK1 to output the low voltage. Successively, when the voltage at the contact J1 reaches the low voltage due to complete discharge of the capacitor C3, the transistor T14 is turned off to disconnect the output terminal OUT2 from the clock signal CLK1, and thereby the carry output Cout(j) is in a floating state and remains low. At the same time, since the output terminal OUT1 is connected to the low voltage via the transistor T2 irrespective of the turn-off state of the transistor T1, the low voltage is outputted. Here, since the gate output[Gout(j+1)] of the next stage STj+1 is applied to the transistor T14 connected to the previous gate line Gj, the transistor T14 is turned on such that the gate-off voltage Voff is output to the gate line Gj. Then, the gate line Gj is fixed with low voltage once more.

On the other hand, the transistors T12 and T13 are turned off, and thereby the contact J3 is in a floating state. Additionally, since a voltage at the contact J5 is lower than that at the contact J4 and the voltage at the contact J3 remains lower than that at the contact J5 by the capacitor C1, the transistor T7 is turned off. At the same time, the transistor T8 is turned off and the voltage at the contact J4 decreases, and thereby the transistor T3 remains turned off. Additionally, the transistor T10 is connected to the low voltage of the gate clock signal CLK1 and the voltage at the contact J2 is low, and thus the transistor T10 remains turned off.

Subsequently, since the transistors T12 and T7 are turned on due to the high voltage of the clock signal CLK1 and thus the increase of the voltage at the contact J4 turns on the transistor T3 to transmit the low voltage to the contact J2, the output terminal OUT1 outputs the low voltage continuously. That is, even though the next gate output Gout(j+1) is low, the voltage at the contact J2 is made to be the low voltage.

Additionally, the gate of the transistor T10 is connected to the high voltage of the clock signal CLK1 and the voltage at the contact J2 is the low voltage, and thus the transistor T10 is turned on to transmit the voltage at the contact J2 to the contact J1. On the other hand, the drains of two transistors T1 and T14 are connected to the clock terminal CK1 to be continuously applied with the clock signal CLK1. In particular, the transistor T1 is formed larger relative to the remaining transistors, and thereby a parasitic capacitance between the gate and the drain thereof is so large that voltage variation of the drain may affect a gate voltage. Accordingly, an increase of the gate voltage due to the parasitic capacitance between the gate and the drain of the transistor T1 on the high voltage of the clock signal CLK1 may turn on the transistor T1. Thus, the transistor T1 is prevented from being turned on such that the gate voltage of the transistor T1 maintains the low voltage by transmitting the low voltage at the contact J2 to the contact J1.

Then, the voltage at the contact J1 maintains the low voltage until the previous carry output Cout(j−1) becomes high, the voltage at the contact J2 is the low voltage via the transistor T3 when the clock signal CLK1 is high and the clock signal CLK2 is low, and the voltage at the contact J2 is the low voltage via the transistor T5 when the clock signal CLK1 is low and the clock signal CLK2 is high.

In addition, the transistor T6 is supplied with the initializing signal INT outputted from the last dummy stage STn+1 to transmit the gate-off voltage Voff to the contact J1, thereby setting the voltage at the contact J1 to be the low voltage once more.

Each stage 410 generates the carry signal Cout(j) and the gate output Gout(j) synchronized with the clock signals CLK1 and CLK2 in response to the previous carry signal Cout(j−1) and the next gate output Gout(j+1).

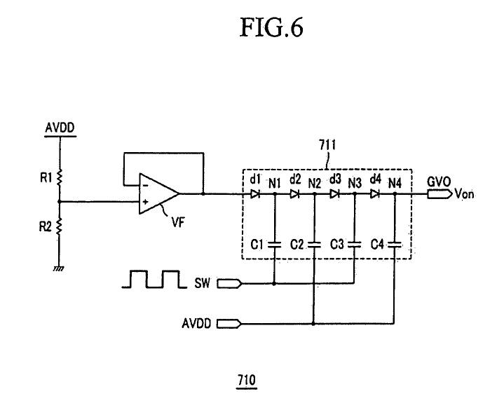

Next, a gate-on voltage generator according to an exemplary embodiment of the present invention will be described in detail with reference to FIGS. 6 to 8.

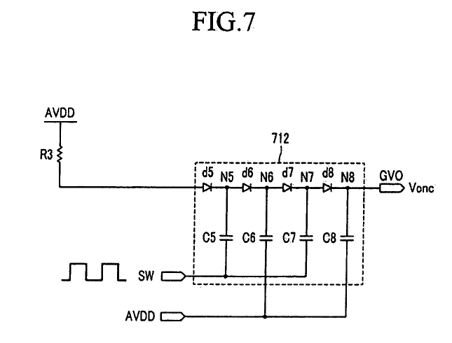

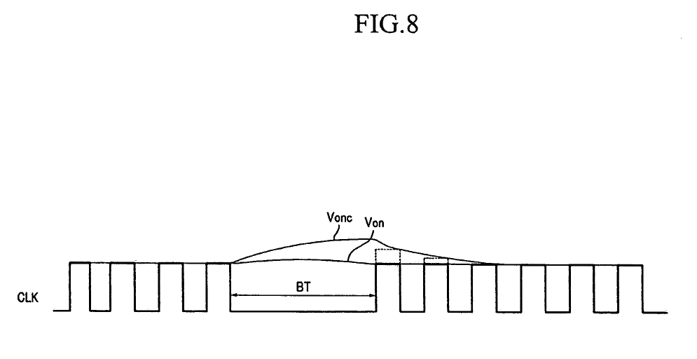

FIG. 6 is a circuit diagram of an exemplary embodiment of a gate-on voltage generator of the gate voltage generator shown in FIG. 1, FIG. 7 is a circuit diagram of a conventional gate-on voltage generator, and FIG. 8 is a view of signal waveforms comparing the gate-on voltages of the gate-on voltage generators according to the present invention and the conventional art.

Referring to FIG. 6, a gate-on voltage generator 710 according to an exemplary embodiment of the present invention includes a plurality of resistors R1 and R2 connected between a reference voltage AVDD and a ground voltage, a voltage follower VF connected to the contact of two resistors R1 and R2, and a charge pump circuit 711.

The charge pump circuit 711 includes first, second, third and fourth diodes d1-d4 connected between the voltage follower VF and a gate-on voltage output terminal GVO, and first, second, third and fourth capacitors C1, C2, C3, and C4. One terminal of each of the first, second and third capacitors C1, C2, and C3 is connected between the first diode d1 and the second diode d2, the second diode d2 and the third diode d3, and the third diode d3 and fourth diode d4, respectively, and one terminal of the fourth capacitor C4 is connected between the gate-on voltage output terminal GVO and the fourth diode d4. The other terminals of the first and third capacitors C1 and C3 receive a switching voltage SW, and the other terminals of the second and fourth capacitors C2 and C4 receive a reference voltage AVDD.

In the current exemplary embodiment, the gate-on voltage Von is about 28V, and the gate-off voltage Voff is approximately −10V. Also, the reference voltage AVDD is approximately 12V, and the switching voltage SW is a periodic function having values in the range of from approximately 0V to 12V.

The process of generating the gate-on voltage Von will described using the above exemplary values.

Even though the threshold voltage of the diodes d1-d4 is generally in the range of approximately 0.5V to 0.7V, it is calculated as 0V for convenience of calculation. That is, since the diodes d1-d4 are a linear circuit, the voltage of approximately 2.0 to 2.8V as the sums of the threshold voltages of the four diodes d1-d4 is subtracted from the next calculation result.

On the other hand, the resistances of the two resistors R1 and R2 are the same, and accordingly, the reference voltage AVDD is half because of the two resistors R1 and R2 such that the voltage follower VF receives 6V.

The voltage follower VF transmits 6V to the anode terminal of the first diode d1, and because the threshold voltages of the diodes d1-d4 are 0V, the voltages of all nodes N1-N4 become 6V.

Here, the switching voltage SW is 0V, and the voltages charged in each of the capacitors C1-C4 become 6V, −6V, 6V, and −6V with reference to the nodes N1-N4.

Next, if the switching voltage SW changes to 12V, the other terminals of the first and third capacitors C1 and C3 change to 12V and the voltages of the first node N1 and the third node N3 change to 18V. Also, the voltages of the first and third nodes N1 and N3 are respectively transmitted to the second and fourth nodes N2 and N4 as they are such that the voltages of the second and fourth nodes N2 and N4 also become 18V.

Next, when the switching voltage SW becomes 0V, the voltage of the first node N1 is dropped to 6V such that the second diode d2 is turned off. At this time, however, the voltage of the third node N3 drops, and the voltage of 18V of the second N2 is transmitted to the third node N3 such that the voltage of the third node N3 becomes 18V. At this time, because the fourth diode d4 is turned off due to the temporary voltage drop of the third node N3, the fourth diode d4 is floated such that the voltage of the fourth diode d4 is maintained at the previous voltage.

Next, when the switching voltage SW becomes 12V, the voltage of the first node N1 becomes 18V, the voltage of the third node N3 becomes 30V by adding 12V to the previous voltage of 18V such that the fourth diode d4 is turned on, and this voltage is transmitted to the fourth node N4, and accordingly the gate-on voltage Von is output as 30V.

When the switching voltage SW again becomes 0V, the voltage of the third node N3 is changed to 18V, and the anode voltage of the fourth diode d4 is less than the cathode voltage such that the fourth diode d4 is floated. Accordingly, the fourth capacitor C4 comes to be in a floating state and continuously outputs the previous voltage of 30V.

The sum 2.0V to 2.8V of the threshold voltage of the diodes d1-d4 is subtracted from the result such that the result of the gate-on voltage becomes approximately 27.2V to 28V.

The gate-on voltage Von and the gate-off voltage Voff that are generated in this way are input to the clock signal generator 750, and the clock signal generator 750 generates clock signals CLK1 and CLK2 based on the gate voltages Von and Voff and outputs the clock signals CLK1 and CLK2 to the gate driver 400.

Referring to FIG. 7, a conventional gate-on voltage generator which includes a charge pump circuit 712 having a plurality of diodes d5-d8 and a plurality of capacitors C5-C8 is the same as that of the gate-on voltage generator 710 according to an exemplary embodiment of the present invention.

However, a reference voltage AVDD is directly input to the anode of the diode d5 after being reduced by the resistor R3, differently from the gate-on voltage generator 710 according to an exemplary embodiment of the present invention.

When the change of the load occurs, the input terminal of the charge pump circuit 712, i.e., the fifth diode d5, is affected thereby, and the gate-on voltage Vonc is increased. This will be described in detail with reference to FIG. 8.

A clock signal CLK shown in FIG. 8 is one of the clock signals CLK1 and CLK2.

As shown in FIG. 8, a blank time BT in which a clock signal CLK is not output exists between the frames. The clock signal generator 750 and the gate driver 400 do not operate during the blank time BT, and temporary disconnections between the gate-on voltage generator 710 and other driving circuits, the gate driver 400 and the clock signal generator 750 occurs.

The circuit shown in FIG. 7 has the current path from the reference voltage AVDD to the output terminal GVO via the charge pump circuit 712. However, there is no current flowing during the blank time BT. Therefore, the reference voltage AVDD is transmitted to the anode of the diode d5 as it is without the voltage drop by the resistor R3. However, the switching voltage SW is continuously applied to the charge pump circuit 712 at this time, and a gate-on voltage Vonc that is larger than the gate-on voltage Vonc generated during the time except at the blank time BK is generated.

Like the description with reference to FIG. 6 when the charge pump circuit 711 receives 6V, because the gate-on voltage generator 710 generates 30V, when the charge pump circuit 712 in FIG. 7 receives 12V the gate-on voltage generator according to the conventional art generates 36V by adding 6V. Accordingly, the gate-on voltage generator 710 generates the gate-on voltage Vonc to be close to or over the limiting value of the operation specification of the gate voltage generator 710 such that a reduction of lifetime thereof is caused. Furthermore, as shown by the dotted outline in FIG. 8, if the clock signal CLK that is generated based on the gate-on voltage Vonc also exceeds the limit value, the transistors T1-T15 of the gate driver 400 and the switching element Q receive the excess stress such that a reduction of their lifetime may be caused.

However, the gate-on voltage generator 710 according to an exemplary embodiment of the present invention includes the voltage follower VF which prevents the influence due to the changes of the load before the charge pump circuit 711. That is, since the input impedance of the voltage follower VF is infinite and the output impedance thereof is zero, the voltage follower VF plays a role of dividing the front and later parts thereof. Therefore, the voltage follower VF inputs a uniform voltage to the charge pump circuit 711, such that the charge pump circuit 711 receives 6V. Accordingly, the gate-on voltage Von is output with a value having a sufficient margin from the limiting value, and a gate-on voltage Von having an increased value of 1.5V is measured during the blank time BT as a result.

Furthermore, the resistor R3 shown in FIG. 7 is coupled in series between the reference voltage AVDD and the charge pump circuit 712, and the resistance for generating the voltage drop of 6V has little limiting value. For example, the resistance of the resistor R3 is approximately 300Ω (ohm), and the current of 20 mA flows through the resistor R3 and the power of 120 mW is consumed. Also, when the value exceeds the limiting value of 100 mW, the resistor R3 receives excessive stress.

However, because the resistances of the two resistors R1 and R2 are equal to each other in the exemplary embodiment shown in FIG. 6, the selection of the two resistors R1 and R2 is relatively easy.

That is, if the resistances of the two resistors R1 and R2 are more than 360Ω, because the power is less than the limiting value of 100 mW, the room for the selection is great and the stress on the resistor may be reduced.

As above-described, the voltage follower VF is disposed in front of the charge pump circuit 711 such that the influence due to the load changes may be blocked, thereby preventing the excessive increase of the gate-on voltage Vonc during the blank time BT. Furthermore, two resistors having the same resistance are used to divide the reference voltage such that the stress on the resistors may be minimized.

While the present invention has been shown and described with reference to some exemplary embodiments thereof, it should be understood by those of ordinary skill in the art that various changes in form and details may be made therein without departing from the spirit and scope of present invention as defined by the appending claims.

What is claimed is:

1. A driving apparatus for a liquid crystal display, the driving apparatus comprising:
a gate-on voltage generator which generates a gate-on voltage and a gate-off voltage generator which generates a gate-off voltage the gate-on voltage generator comprises:
first and second resistors connected between a predetermined reference voltage and a ground voltage;
a voltage follower connected to a contact between the first resistor and the second resistor;
a charge pump circuit connected to an output terminal of the voltage follower; and
a gate-on voltage output terminal connected to the charge pump circuit.

2. The driving apparatus of claim 1, wherein the first and second resistors include a same resistance.

3. The driving apparatus of claim 2, wherein
the charge pump circuit comprises:
first, second, third and fourth diodes sequentially connected between the output terminal of the voltage follower and the gate-on voltage output terminal;
a first capacitor including a terminal connected to a first node between the first diode and the second diode, and another terminal which receives a switching voltage;
a second capacitor including a terminal connected to a second node between the second diode and the third diode, and another terminal which receives the reference voltage;
a third capacitor including a terminal connected to a third node between the third diode and the fourth diode, and another terminal which receives the switching voltage; and
a fourth capacitor including a terminal connected to a fourth node between the fourth diode and the gate-on voltage output terminal, and another terminal which receives the reference voltage.

4. The driving apparatus of claim 3, further comprising:
a clock signal generator which receives the gate-on voltage and the gate-off voltage, and generates a plurality of clock signals.

5. The driving apparatus of claim 4, further comprising:
a gate driver which generates gate voltages based on the clock signals.

6. The driving apparatus of claim 5, wherein the gate driver includes a plurality of stages which sequentially generate the gate voltages,
and the stages are integrated on the liquid crystal display.

7. The driving apparatus of claim 1, wherein
the reference voltage is approximately 12V, and the switching voltage includes a value of approximately 0V to approximately 12V.

8. The liquid crystal display comprising:
a plurality of pixels disposed in a matrix and a plurality of switching elements connected to the pixels;
a gate driver which generates driving voltages for sequentially turning on and turning off the switching elements; and
a gate voltage generator including a gate-on voltage generator which generates a gate-on voltage and a gate-off voltage generator which generates a gate-off voltage, the gate-on voltage generator comprises:
first and second resistors connected between a predetermined reference voltage and a ground voltage,
a voltage follower connected to a contact between the first resistor and the second resistor,
a charge pump circuit connected to an output terminal of the voltage follower, and
a gate-on voltage output terminal connected to the charge pump circuit

9. The liquid crystal display of claim 8, wherein the first and second resistors including a same resistance.

10. The liquid crystal display of claim 9, wherein
the charge pump circuit comprises:
first, second, third and fourth diodes sequentially connected between the output terminal of the voltage follower and the gate-on voltage output terminal;
a first capacitor including a terminal connected to a first node between the first diode and the second diode, and another terminal which receives a switching voltage;
a second capacitor including a terminal connected to a second node between the second diode and the third diode, and another terminal which receives the reference voltage;
a third capacitor including a terminal connected to a third node between the third diode and the fourth diode, and another terminal of the third capacitor which receives the switching voltage; and
a fourth capacitor including a terminal connected to a fourth node between the fourth diode and the gate-on voltage output terminal, and another terminal which receives the reference voltage.

11. The liquid crystal display of claim 10, further comprising
a clock signal generator which receives the gate-on voltage and the gate-off voltage, and generates a plurality of clock signals.

12. The liquid crystal display of claim 11, wherein
the gate driver generates the driving voltages based on the clock signals.

13. The liquid crystal display of claim 12, wherein
the gate driver includes a plurality of stages which sequentially generate the driving voltages,
and the stages are integrated on the liquid crystal display.
